(19) United States
(12) Patent Application Publication
(10) Pub. No.: US 2003/0038922 A1
(43) Pub. Date: Feb. 27, 2003

(54) Apparatus and method for displaying 4-D images

(76) Inventor: Stanford L. Ferrell, Sierra Vista, AZ (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 09/934,504

(22) Filed: Aug. 22, 2001

(51) Int. Cl. G03B 21/32

(52) U.S. Cl. 352/85

(57) ABSTRACT

There is provided a deep screen reality imaging method and apparatus that includes a projector or video for providing image-bearing incident light and a translucent rear projection surface for extracting foreground, subject, and background image information from this image-bearing incident light. This translucent rear projection surface has an image panel containing prioritized background information for providing a background image between a second and third plural imaging region, an image panel containing prioritized subject visual information for providing optically neutral void area and subject image between a first and second plural imaging region, and image panel containing prioritized foreground visual information for providing optically neutral void area and foreground image before a first plural image region. The image panels transmit and reflect light into semi reflective transmission panels within a darkened optical manifold, a first panel for categorizing extraction and displacement mapping, a second panel for categorizing interpolation and texture mapping, and a third panel for converging multiple layers of visual information that further transmit an image into a primary light trap for displaying a plural 4-dimensional composite image containing interpolated qualities from visual information striking the semi reflective transmissions panels. A variation of this invention can be adapted to video display configuration.

### BACKGROUND OF THE INVENTION

The present invention relates to synthetic holographic visual simulation convergences and more particularly to 4-dimensional visual imaging, which are used, for example, in the presentation of cinema, video, computer games and virtual reality simulations.

Individuals have eyes that receive about the same images in color shading and density. However, each individual receives these images slightly different from other individuals. Although individuals automatically have the same center point for everything they see, each sees just a bit off the opposite site from the other eye. The right eye will see more around the right side and the left eye will see more around the left side. This is known as parallax. The closer the object the more roundness is perceived, and the further back there is less roundness. Close-up items appear with more depth and optical volume, while objects several feet away begin to lose their roundness and depth. The brain gathers this optical material, by determination of the center point, and images the two eyes together into a fully dimensional representative scene. Consequently, in order for the brain to reconstruct a realistic representation of a simulated scene the visual information must contain parallax, optical volume and depth.

In the past, apparatuses designed to project or display visual information, in 3-dimension or 4-dimension, were focused on carefully controlling the presentation of the left and right images to the respective eyes that view such visual information. The images on the lower fringes of 3-dimension were perceived once the brain interpolated the visual disparity of the right and left image. Although such images crudely contain parallax, optical volume, and depth, the brain was able to make quick adjustments to the visual disparity. In shifting the convergence of near and far objects contained in the left and right images in milliseconds, the brain allowed the perception of depth without one being aware of this splitting of imagery. Unfortunately, the older an individual becomes the more conscious they are of the disparity of the left and right images. Consequently, a problem associated with this process and apparatus is that optical corrective devices, such as lenticular filter sheets, filter glasses, or LCD goggles, are required for an individual to properly view in 3-dimension from a 2-dimension plane.

In general, 3-dimension and 4-dimension imagery uses the disparity of the left and right images produced in a film or video. These images are projected onto a screen, displayed on a cathode ray tube (CRT), or liquid crystal display (LCD) monitor, and must be viewed through another device such as a lenticular filter placed over the CRT/LCD monitor, or filter glasses worn by the viewer. These filters deliver separate images that the brain interprets as it does with the stereoscopic imagery normally seen. Consequently, a problem associated with 3-dimension and 4-dimension imagery is that a filter is required for these images to be produced.

There exists the “Cross-Over” method for viewing 2-dimensional images in either 3-dimension or 4-dimension. This process displays the disparity of the left and right image, in a side-by-side orientation, with the right image on the left side of the display and the right image on the left side of the display. In order for the viewer to interpret the visual information in 3-dimension, they must go through a series of eye-straining muscular movements to focus on the right and left images, and then bring them together mentally by physically adjusting their eyes. This process is an inexpensive 3-dimension display that is free from relying on filters, glasses or goggles for viewing. However, the viewer must undergo an unnatural fixation on the formatted display in order to see the resultant 3-demensional image. Consequently, sustained viewing of 3-dimension material in this format becomes difficult for periods longer than 15-20 seconds, if not completely unbearable to some viewers. Furthermore, the eyes require several minutes of inactivity afterwards in order to relax strained eye muscles, allowing them to return to a natural viewing state. Also, this process does not provide the basic elements of true 3-dimension or 4-dimension imagery.

Yet another approach of the prior art for viewing a display of a 3-dimensional or 4-dimensional visual image is the use of an immersive space that relies on an enhanced sense of depth. For example, one approach uses a specially curved screen with a domed top that enables overhead views, a flattened bottom allowing a floor view, and a curved mid-section that provides imaging surface. This enhanced sensor display projects 2-dimensional computer generated imagery onto a curved surface that approximates the volume and shape of the human eye. Additional sense of depth is reinforced through the use of shaded computer modeling, and other imaging software designed to equate straight-line artwork when projected on a curved viewing surface. However, these images are by no means 3-dimension with the results being non-auto stereoscopic. The curved dome 3-dimension projection configurations do not provide the disparity of right and left images. Furthermore, a problem associated with false sensory depth using a curved projection screen is a prohibitive increase in the size of the screen.

One approach that allows viewing of an auto stereoscopic, 3-dimension and 4-dimension, display involves projecting a sequence of cross sectional slices on a screen whose diameter is changing. If the moving speed of the screen and the scanning speed of the images are fast enough, and synchronized properly, the 3-dimensional images can be recognized by an after image effect on human eyes. This approach has traditionally been used in a volumetric image simulation environment where the spinning (rotating) projection surfaces are essentially flat. In a slightly different approach, there is a 360-degree spiral that slightly varies the flat projection surface and reduces the required sweep area increasing the overall optical volume. In some cases the projected image must be viewed through a translucent spinning rear projection surface. Alternatively, the visual material is observed as images falling directly onto the spinning surface. However, the resultant 3-dimensional images from the spinning projection are inaccurate. The synchronization of the spinning projection surface in conjunction with sub pixel points of light, from the image source that supplies individual illuminated pixels of only a fraction of the entire image approaching about a micron in size, dictates that the degree of error within each synchronization cycle is infinite. All magnitude of vibration disrupts the physical characteristics of the internal structures required to synthesize the volumetric images. This reduces the applicability of this method to strictly controlled environments with costly countermeasures to eliminate errors. Also this method is size limited due to its delicate mechanical nature.

The use of layered graphic electronic displays using two original images is another way to view auto-stereoscopic images. This involves the alignment of either a front liquid crystal display (LCD) imaging panel placed in front of a video display terminal (VDT), or the reflection of high-definition (Hi-Def) images off of a front-wave beam-splitter placed in front of a secondary Hi-Def/VDT supplying background information. In both applications computer generated 2.5-dimensional shaded imagery is adequate to provide the illusion of a 3-dimensional image viewed on the front panel, floating in front of a 2-dimensional background image visible on the secondary display through the front panel. However, while such images give a realistic sensation to depth they have no look around capability. An observer moving their head while viewing such an image is looking at graphic text, or full-screen imagery placed in front of a corresponding background image, that contain the basic elements of parallax and depth, but optical volume is not achieved. The movement of the head causes the foreground image to shift slightly, but no occluded visual information comes into view. Consequently a true 3-dimensional image is not achieved, as this requires parallax, depth and optical volume. Also, the perspective between foreground and background images remains the same with respect to a 4-dimensional image. The introduction of 4-dimensional qualities is critical because it allows the displacement of images into virtual infinity in space-time through the use of optical volume. Furthermore, this method of 3-dimensional display is expensive with Hi-Def display terminals. It presents problems regarding size limitations and computation time with respect to multi-faceted memory needed to store and display, foreground and background, information separately.

An exotic solution for viewing auto stereoscopic visual information is the observation of excited particles in gas or crystal molecular state. This is accomplished through controlled introduction of an energy beam into a gas-filled chamber, or rare-earth crystal cube, in order to strike natural-state gas particles or crystals. The gas particles or crystals give off a brief glow of light upon release of the additional energy, provided by the directed beam, as they return back to their natural state. This type of crystal-molecular stimulated emission of light, referred to as volumetric display, rely on the ability to focus one or more energy beams to a specific locus (xyz-axis) in space-time affecting one or more of the suspended particles. However, a problem of size exits with using volumetric displays, and require an enormous amount of computational and rendering time in order to precisely control the movement of the energy beams within the volume. The larger the gas chamber, or crystal, the greater the computations and increased rendering time that is required to redirect multiple energy beams to the appropriate point in space and time to affect the gas particles, crystals or molecules. The volumetric displays excite light emitting particles suspended in space and time within a chamber (height, width, and depth). Consequently, computational requirements are cubed rather than squared resulting in an apparent real-time image that is inversely proportional to the volumetric space.

### SUMMARY OF THE INVENTION

It is an aspect of this invention to eliminate the need for lenticular filters, filter-glasses, and LCD-goggles, by assigning multiple, separate, and distinct layers of visual information to stacked optical image planes that are further converged into a single volumetric image, rather than present left and right images of a scene relying on the brain's ability to interpolate the interocular disparity between the center points of those left and right images.

Another aspect of this invention is to create a truly 3-dimensional or 4-dimensional image using parallax, depth, and optical volume instead of optical illusion provided by the prior art.

It is further another aspect of this invention to provide plural image regions of a scene arranged along an optical axis point with depth, volume, and surface area that increases volumetrically the amount of available information of the basic 3-dimensional ques resulting in a 4-dimensional image that is highly desirable for natural mental extraction of parallax, depth and optical volume.

There is provided a deep screen reality imaging method and apparatus that includes a projector or video for providing image-bearing incident light and a translucent rear projection surface for extracting foreground, subject, and background image information from this image-bearing incident light. This translucent rear projection surface has an image panel containing prioritized background information for providing a background image between a second and third plural imaging region, an image panel containing prioritized subject visual information for providing optically neutral void area and subject image between a first and second plural imaging region, and image panel containing prioritized foreground visual information for providing optically neutral void area and foreground image before a first plural image region. The image panels transmit and reflect light into semi reflective transmission panels within a darkened optical manifold, a first panel for categorizing extraction and displacement mapping, a second panel for categorizing interpolation and texture mapping, and a third panel for converging multiple layers of visual information that further transmit an image into a primary light trap for displaying a plural 4-dimensional composite image containing interpolated qualities from visual information striking the semi reflective transmissions panels. A variation of this invention can be adapted to video display configuration.

These and other aspects of he invention will become apparent from the following description, the description being used to illustrate the preferred embodiment of the invention when read in conjunction with the accompanying drawings.

### BRIEF DESCRIPTION OF THE DRAWINGS

FIG. 1 is a side view of deep screen reality 4-dimensional technology used in cinema configuration of the preferred embodiment of the claimed invention.

FIG. 2 is a top view of deep screen reality 4-dimensional technology used in cinema configuration of the preferred embodiment of the claimed invention.

FIG. 3 is an exploded view of deep screen reality 4-dimension convergence effect upon a polynomial image transmission line of the preferred embodiment of the claimed invention.

FIG. 4 is a side view of deep screen reality 4-dimensional technology used in video display configuration of the preferred embodiment of the claimed invention.

FIG. 5 is an exploded view of deep screen reality 4-dimensional video convergence effect upon a binomial image transmission of the preferred embodiment of the claimed invention.

FIG. 6 is a flow chart of deep screen reality 4-dimensional technology of the preferred embodiment of the claimed invention.

### DETAILED DESCRIPTION OF THE INVENTION

While the claimed invention is described below with reference to use in cinema and video applications, a practitioner in the art will recognize the principles of the claimed invention are applicable to other applications as discussed supra.

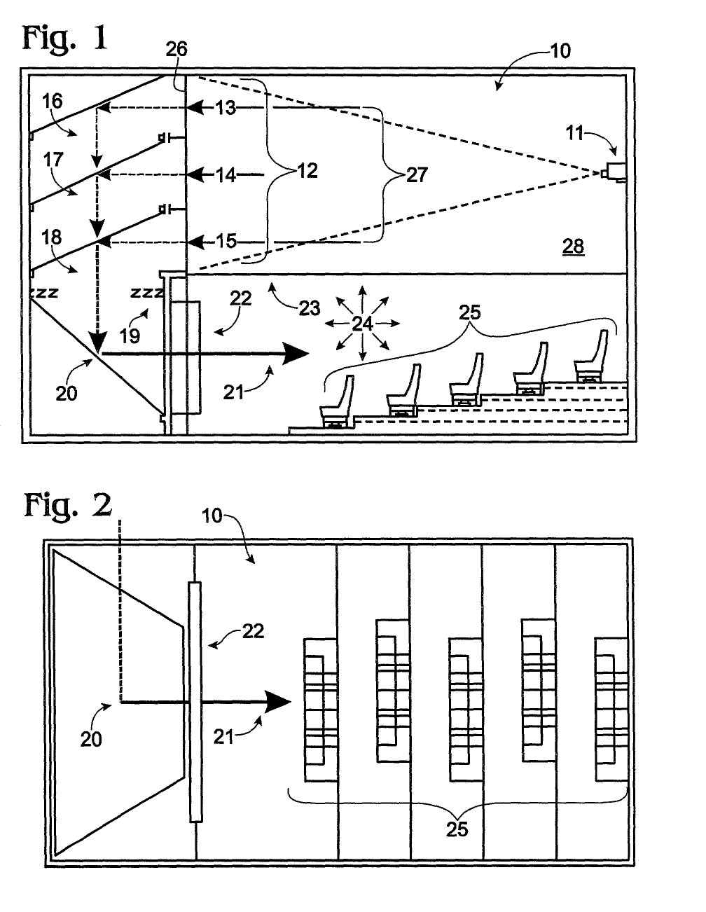

Now referring to FIG. 1, apparatus 10 is the preferred embodiment of the deep screen reality 4-dimensional imaging technology for cinema applications. A null for the foreground optical plane is created using a prioritization mechanism physically determined by semi reflectance-transmittance (R/T) values. The input data required includes a digital projection 11, using liquid crystal display (LCD), or digital light processing (DLP), with the representative aggregate image bearing light 12. One who is a practitioner in the art will readily see that a traditional motion picture film may be substituted for a digital projector 11 using 8 mm through 70 mm motion picture film. The prioritization mechanism further assigns priority in accordance with the chromanance and luminance of the foreground image source 15, and the reflectance-transmittance properties of the foreground optical panel 18, arrayed along the longitudinal path directly following the first plural imaging region. These factors are then computed in relation to the visual amplitude of the subject image source 14, and the reflectance-transmittance properties of the subject image panel 17, arrayed along the longitudinal path between the first and second imaging regions. The first and second imaging regions are combined and further prioritized using this mechanism in order to determine the proper illumination amplitude adjustment for the background image source 13. The combination is in relation to the reflectance-transmittance properties of a background image panel 16, arrayed along a longitudinal path between the second and third plural imaging regions. The panels are arrayed at 45 degrees parallel to the corresponding independent image extraction region.

Each discrete image source is assigned to a predetermined portion of the visual display surface that is prioritized from top to bottom. In situations involving cinema projection the foreground, subject and background image information is extracted through a translucent rear-projection surface 26 positioned parallel to the plural imaging regions, the background image source 13, the subject image source 14, and the foreground image source 15, within an optical manifold 27 from the image bearing light 12. The rear-projection surface 26 may be either a flexible membranous material or a glass. The rear-projection surface separates regions 13, 14, and 15 from 16, 17 and 18.

Once the physical characteristics of the plural layers of visual information have been interpolated and arrayed using the prioritization mechanism, the inherent self-contained properties within each independent image source can now be extracted and converged to form the alternate 4-dimensional visual reality. The inherent opaque and occlusive characteristics of the foreground image source 15, the subject image source 14, and the background image source 13, are distinguished through the use of invariant semi reflective-transmittance (R/T) imaging panels that are the background image panel 16, the subject image panel 17, and the foreground image panel 18. The 2-dimensional image source 12 is converged into the 4-dimensional format. This convergence effect takes place through the interaction of multiple sources of 2-dimensional light waves, the foreground image source 15, the subject image source 14, and the background image source 13, against a polynomial optical conduit. This optical conduit can be described through the formula:

(X to the power of 3)+3X+2

This formula makes it possible to combine linear (R/T) optical imaging panels that are integral powers of a given set of variables with constant coefficients. The (R/T) imaging panels are combined and manipulated allowing image integration along the longitudinal depth of the optical manifold. These (R/T) imaging panels arrayed along the longitudinal depth of optical manifold are construed at right angles to one another. The configuration results in the emission of all possible light waves relative to the discrete image source that is the combination from the foreground image panel 16, the subject image panel 17, and the background image pane 18. The invariant (R/T) panels consist of an aluminized first surface adhered to a flat, rigid, and optically neutral substrate located superior to a secondary light-trap 19. The secondary light-trap 19 is also known as the virtual reality portal within the optical manifold of the foreground image source 15, subject image source 14, and background image source 13. For example, in the configuration for deep screen reality 4-dimensional cinema projection, the (R/T) values are about: foreground imaging panel (R=70%/T=30%); subject imaging panel (R=50%/T=50%); and background imaging panel (R=35%/T=65%).

Under these constraints, the eclipsing, total or partial obscuring, of inferior images by superior images within the darkened optical manifold occurs. In addition, enhanced image occulation, a state of being hidden from view, is achieved through the shutting off of light by the superior images due to the respective R-value of the image panels. Meanwhile, full parallax and depth of scene are achieved through the creation of conceptual volumetric properties. The respective T-values of the image panels allow transmission of light from inferior images through optically neutral voids contained in any superior image region.

A uniform neutral density optical volume is generated, converting the multiple layers of the 2-dimensional visual information into 4-dimensional information within the visible spectral domain. This is further extended into the spatial domain through the use of a final 100% reflective heads-up display R-panel 20. Any portion of the discrete image sources containing light are reflected from a first-surface of the R-panel 20 without passing through the substrate that minimizes light loss and secondary refraction. The light emitting images reflected from a final heads-up panel of display R-panel 20 are converged through prior passive control of the intensity of transmitted light base on the assigned invariant (R/T) values. All extraction, transduction, and convergence of the original layered 2-dimensional image 12 take place at the secondary light trap 19 resulting in the synthesized holographic 4-dimensional composite image.

The resultant synthetic composite hologram is trapped within the overall apparatus 10 through use of a primary light-trap virtual reality portal 22 before being viewed within a darkened auditorium 24. In deep screen reality 4-dimensional cinema configuration it is important that theater seating be situated in a stadium-style arrangement 25, with the center seat vertically and horizontally posited in-line to view the in-line image 21 from the primary light trap 22. Consequently, the conceptual reality from R-panel 20, of the presented visual images, may be viewed from any seat without the need for filters, viewing glasses or special goggles. The 4-dimensional reality reveals parallax, depth, and volumetric attributes inherent specifically to the viewer's location within the auditorium 25. In other words, viewers are able to see and experience a completely different visual account, of the pluralized auto stereoscopic reality, based on their relative position to the in-line image 21 from the primary light trap 22. Finally, a separation 23 must occur between the auditorium 25 and the projection region 28 of apparatus 10.

FIG. 2 is a top view of apparatus 10 showing the interaction of the converged synthetic hologram 20 with respect to the in-line image 21, from the primary light trap 22, and the auditorium 25 seating arrangement.

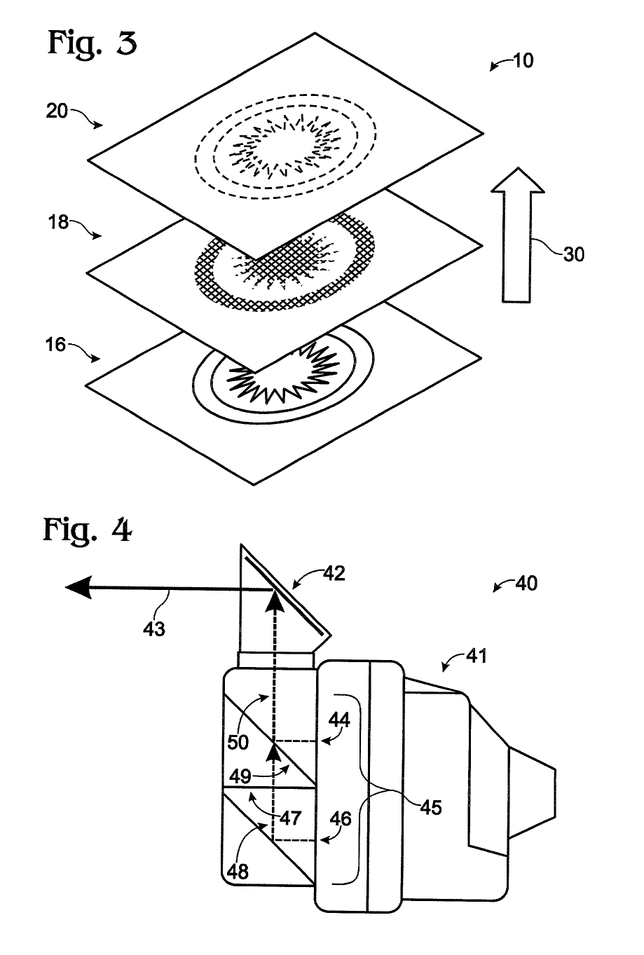

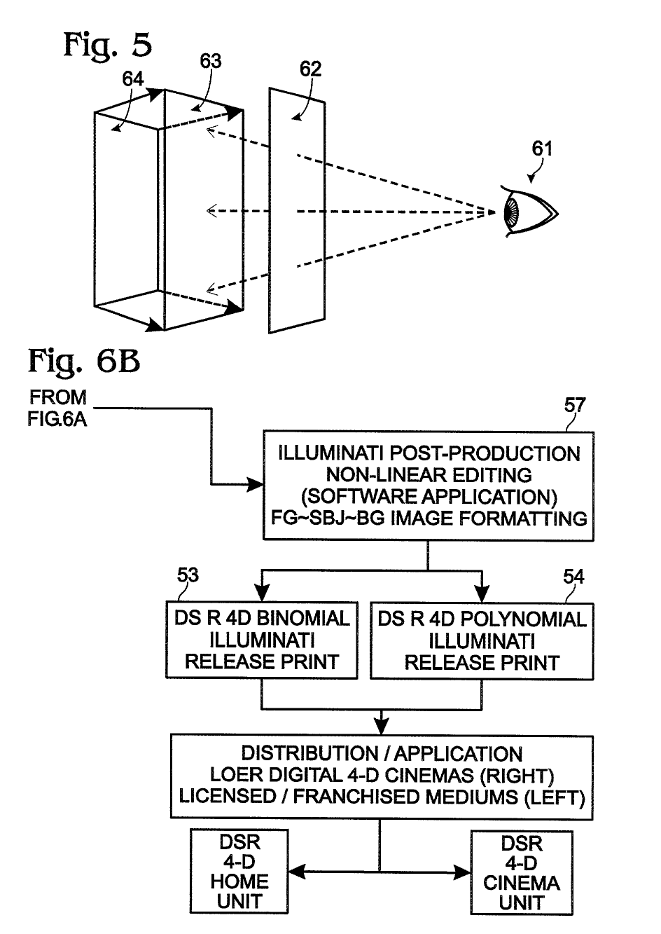

In FIG. 3, is an exploded view of the deep screen reality 4-dimensional convergence effect upon a polynomial image transmission. The first effect is the extraction and displacement mapping of the foreground image source 15. The next effect is the interpolation and texture mapping and the foreground image panel 18. Finally, the last effect is the convergence of all images, foreground, subject and background at the R-panel 20. This effect follows the path 30 and is the prioritization mechanism. The respective effects also occur for the subject image source 14 and background image source 13, as seen in FIG. 1. The prioritization mechanism is implemented using off the shelf algorithmic non-linear editing and extraction software to prepare the projection image, either digital or traditional motion picture film, before the prioritization mechanism of the apparatus 10 can occur. The computed data may be stored as an analog or digital signal using any traditional film or digital medium, this remaining unchanged for each new presentation.

In FIG. 4, deep screen reality 4-demensional images are displayed using a video apparatus 40 that includes a video display terminal 41 with video, or video games, from a DVD or VCR format. The aggregate image bearing incident light 45 is from the video display terminal 41. A priority is assigned in accordance with the chrominance and luminance of the foreground-subject image source 44, and the reflectance-transmittance (R/T) properties of the foreground optical panel 50, arrayed along the longitudinal path directly following the first plural imaging region. This image is then correlated to the illumination amplitude of the subject-background image source 46, and the reflectance-transmittance (R/T) properties of the subject-background image panel 48, arrayed along the longitudinal path between the first and second plural imaging regions. The images from the foreground-subject image source 44 and subject-background image source 46 are integrated and further prioritized using this mechanism, in order to determine the combined amplitude adjustments for the image magnifier panel 47. The transmittance properties of the image magnifier panel 49 are arrayed along the longitudinal path, between the first and second plural imaging regions, that is perpendicular to both (R/T) image panels. The panels are arrayed at 45 degrees parallel to the corresponding image region.

Each discrete image is assigned to a predetermined portion of the visual display surface 42 prioritized from top to bottom. In apparatuses involving a cathode ray tube (CRT), visual digital technology (VDT), liquid crystal display (LCD), Hi-Definition TV, and Large Screen TV displays, the video signal is extracted from the image source 45 by directly associating the foreground-subject image panel 50 and the background-subject image panel 48, within the optical manifold, with their respective foreground-subject image source 44 and background-subject image source 46, displayed on the visual display surface 42. Once the physical characteristics of these plural layers of images have been interpolated and arrayed using the prioritization mechanism, the inherent self-contained properties of each independent image source is extracted and converged to form an alternate 4-dimensional visual reality.

The inherent opaque and occlusive characteristics of the foreground-subject image source 44 and background-subject image source 46, during the convergence of the 2-dimensional visual image into the 4-dimensional visual image, are evolved through the use of the semi reflective-transmittance (R/T) imaging panels that are the foreground-subject image panel 50 and the background-subject image panel 48. The convergence effect occurs through the interaction of multiple sources of 2-dimensional light waves against a binomial optical conduit. This optical conduit can be described by the formula:

(X to the power of 2)+2XY+(y to the power of 2)

This formula makes it possible to combine linear (R/T) imaging panels of integral powers of a given set of variables with constant coefficients. Thus, using the adaptive (R/T) panels by this manipulation, image integration is achieved along the longitudinal depth of the optical manifold 45.

The foreground-subject image panel 50 and the background-subject image panel 48 are arrayed along the longitudinal depth, of the optical manifold 43, at right angles to one another. This results in the emission of all possible light waves relative to the discrete foreground-subject image source 44 and the background-subject image source 46. The invariant (R/T) panels consist of a clear and aluminized first surface that is a flat substrate. The intermediate image magnifier panel 47 that is located between the foreground-subject image panel 50 and the background-subject image panel 48 consists of a clear semi-rigid fresnel lens. For example, in the configuration for deep screen reality 4-dimensional video display, the (R/T) values are about: foreground-subject imaging panel (R=70%/T=30%); and background-subject imaging panel (R=35%/T=65%). The magnifier panel 47 resolving power is equal to 2 times, and the focal length is adjusted in accordance to the primary display 42 diagonal dimensions.

A uniform neutral density optical volume is generated converting the multiple layers of 2-dimensional visual images, the foreground-subject image source 44 and the background-subject image source 46, into 4-dimensional information within the visible spectral domain, that is further extended into the special domain through the use of a final 100% reflective heads-up display 42. The opaque and occlusive characteristics, from each layered subcomponent of the converged images, are synthesized as light from pre-computed imaging sources strike the microscopically imperfect (R/T) surfaces nearest the incident light. The incident light is derived directly from the foreground-subject image source 44 and the background-subject image source 46 emitted by the video display screen 41. Furthermore, any portions of these discrete image sources containing light are reflected from the first surface of their respective (R/T) panel without passing through the substrate. This minimizes light loss and secondary refraction. Conversely, light-emitting images reflected from the (R/T) imaging panels subordinate to any superior imaging panels. They are occluded through passive control of the intensity of the transmitted light based upon the assigned (R/T) values. The extraction, transduction and convergence of layered 2-dimensional images results in a synthesized holographic 4-dimensional composite image. Finally, a practitioner of the art will readily understand that this apparatus 10 can be operated in a still video condition and the heads-up display 42 will provide a 3-dimensional image reality.

Now referring to FIG. 5, a practitioner in the art will see an exploded view of the deep screen reality 4-dimensional video convergence effect upon binomial image transmission. This includes introduction of 3-dimensional depth and full parallax characteristics within a binomial plural imaging optical manifold. The conceptual volumetric properties viewed at point 61 are enhanced through use of an intermediate image magnifier 63 located between distinct image region 62 and image region 64. The magnification of visual information presented at image region 64, by intermediate image magnifier 63, and integration of the optical constraints imposed through the (R/T) values specific to the foreground-subject image panel 62, results in a composite 4-dimensional synthetic hologram that is viewable from an undetermined number of positions at point 61.

Referring to FIGS. 1 through 5 there is method of displaying a deep screen reality imaging apparatus in cinema that includes using digital projection from a video projection system along with traditional film projection. Using that digital and traditional film projection, through an analog to digital format, allows interpolation, extraction and convergence of the visual images. The visual images are then manipulated through a prioritization mechanism, in the apparatus of 2-dimensional visual images, and introduction of invariant image extraction and convergence.

Once again referring to FIGS. 1 through 5 there is a method of displaying a deep screen reality imaging apparatus in video that includes using an after-market attachment affixed to a viewing device, using a stand alone self contained component attached during assembly of an electronic display device, and using visual information stored on analog or digital video media. This allows interpolation, extraction and convergence of the information. Then the visual images are manipulated through a prioritization mechanism, in the apparatus of 2-demensional visual images, and introduction of invariant image extraction and convergence.

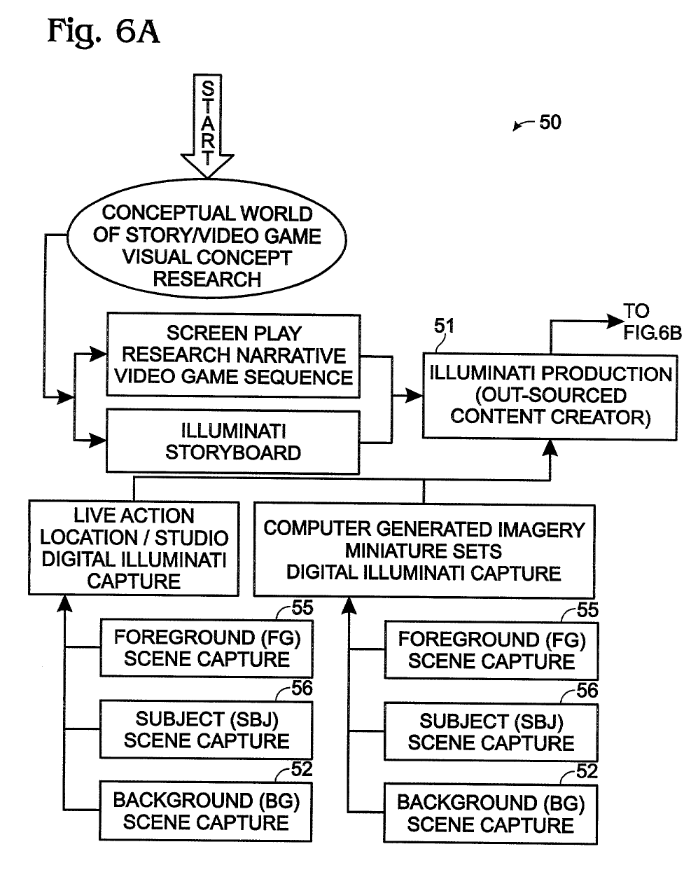

FIG. 6 is a flow chart 50 showing the process that creates deep screen reality synthetic 4-dimensional holographic imaging technology. At block 51, the original scene is photographed in pre-determined depth layers comprised of foreground, subject, and background image information. Alternately, existing film or video material can be digitally dissected into approximate depth layers to extract the necessary image material to replicate the depth of the scene. This “Illuminati Format” digitally reconstructs visual scenes, allowing deep screen reality 4-demisonal synthetic holographic technology to work. The existing motion picture or video material requires the use of off-the-shelf non-linear editing software to facilitate re-formatting into synthetic holograms. An extra step is needed to select and render unwanted existing background image material, surrounding the various depth elements, chroma-key blue or green. The newly isolated foreground or subject material is further isolated against black and assigned the appropriate superior image plane. Finally, the original background material, minus the extracted foreground and subject material, is then assigned to the inferior BG image plane 52. However, new motion pictures or video productions may use a blue-screen, green-screen, or even a matte-black screen as a backdrop for live action and miniature photography in order to isolate the various image depth elements during filming. Use of off-the-shelf non-linear editing software facilitates the next step of digital extraction of the selected images, foreground and subject, that is refined during editing, assembly, and formatting. The visual information designated for the foreground or subject image plane uses a chroma-key or neutral black backdrop as the visual information assigned to the background image plane is photographed. The digitally photographed foreground, subject, and background image information is refined, edited, and formatted into deep screen reality (DSR) 4-dimensional illuminati footage 57. The careful manipulation and storage of the various depth and image elements make it possible for the DSR 4-dimensional synthetic holographic image projection system to extract, interpolate, and converge the separate elements into a single image exhibiting the actual or approximate occlusive, parallax, and volumetric properties of the original material.

The illuminati footage is projected, using either a digital or LCD video projector, into the DSR 4-dimensional illuminati optical manifold that consists of a series of rear projection screens and partially silvered glass screens. The separate image information, foreground, subject, and background is optically overlaid onto the respective background through foreground producing the interior-to-superior projected image. The plural images are subjected to an optical coefficient extraction device that ensures the uniform propagation of occlusive, parallax, and volumetric characters layer by layer. The resultant composite image converges on a transparent viewing surface, making it possible to see a completely three dimensional image floating in mid air, from any angle without the need for special glasses or goggles.

In FIG. 6, block 53 shows a wide screen binomial synthetic hologram for use in small screen cinema and small-to-medium screen video applications. This application is a panoramic-high background (BG) 52 at 100% relative to a panoramic-low background (FG) 55 and (SBJ) 56 plural image at 100%, creating a uniformly formatted DSR 4-dimensional synthetic holographic image. The order of image placement is BG 52, followed by FG 55 and SBJ 56, in order to facilitate adjustments in the illumination level of the BG 52 image panel during creation of pre-master composites. The use of a chroma-key finishing overlay is not required for DSR 4-dimensional binomial composites. The BG 52 plural image panel, panoramic-high, is rendered against a black panel of the original film or video. A panoramic-high image panel is a wide-screen DSR 4-dimensional polynomial produced by filming the original footage using only the upper half of the available image area, 100% wide by 50% high, by composing the frame using a reticle placed in the LCD viewfinder serving as a filming guide with the unwanted lower half digitally masked. The resultant image is positioned in the upper portion of the frame and centered. This image will span the entire width of the upper portion of the frame, from left to right, and serves the purpose of reproducing natural visual properties of the scene as if seen from 20 feet to infinity. These characteristics induce natural parallax.

The FG 55 and SBJ 56 plural image panel, panoramic-low, is rendered against a black panel of the original film or video. A panoramic-low image panel is a wide-screen DSR 4-dimensional polynomial produced by filming original footage using the lower half of the available image area, 100% wide by 50% high, by composing the frame using a reticle placed in the LCD viewfinder serving as a filming guide with the unwanted upper half digitally masked. The resultant image is positioned in the lower frame and centered. The percent of illumination for the BG plural image is determined based on the illumination properties of the FG and SBJ image. Minor adjustments in the BG plural image illumination are required to achieve the correct balance between the FG and SBJ image and the BG image in pre-mastered composites. For example, when on-screen action synapses back and forth between the FG and SBJ image plane, and the BG image plane, action on the FG and SBJ image plane must remain solid. Therefore, a reduction of BG plural image illumination below 100% allows the R/T factor, inherent in the associated transmission panel, to render information on the FG and SBJ image panel opaque relative to the weaker illuminated BG image plane. The visual information contained on the BG image plane is occlusive to the viewer. The result is a pre-mastered wide screen binomial DSR 4-dimensional illuminati footage.

In FIG. 6, block 54 shows a wide screen polynomial synthetic hologram for use in medium to large screen cinema and video applications. This application is a panoramic-high background (BG) 52 at 66% relative to a panoramic-mid subject (SBJ) 56 plural image at 42%, and a panoramic-low foreground FG 55 plural image at 66%, creating a uniformly formatted DSR 4-dimensional synthetic holographic image. The polynomial synthetic holograms, consisting of three or more depth imaging planes, eliminate image size disparity during R/T layering after convergence with the illuminati optical manifold. The order of image placement is BG 52, SBJ 56, intermediate composite, followed by FG 55. A chroma-key finishing overlay is necessary for DSR 4-dimensional polynomial composites.

The BG 52 plural image panel, panoramic-high, is rendered against a black panel at 66% of the original film or video. The resultant image is positioned in the upper portion of the frame and centered. The image is slightly shorter than the width of the entire frame, from left to right, when viewed through the holographic portal on the DSR 4-dimensional editing console.

The SBJ 56 plural image panel, panoramic-mid, is rendered against a black panel at 42% of the original film or video. A panoramic-mid image panel is a wide-screen DSR 4-dimensional polynomial produced by filming the original footage using only the middle of the available image area, 100% wide by 50% high, by composing the frame using a reticle placed in the LCD viewfinder serving as a filming guide with the unwanted lower and upper half digitally masked. The BG illumination level is then adjusted using digital editing that renders an intermediate composite. The illumination of the SBJ plural image remains at 100% with minor uniform illumination adjustments for the intermediate composite made during pre-mastering.

The FG 55 plural image panel, panoramic-low, is rendered against a black panel at 66% of the original film or video. The resultant image is overlaid onto the intermediate composite made at SBJ 56 positioned in the lower portion of the frame and centered. The percent of illumination for the FG plural image remains at 100%, with the intermediate composite illumination level adjusted using digital editing functions, resulting is a pre-mastered wide screen polynomial DSR 4-dimensional illuminati footage.

While there has been illustrated and described what is at present considered to be a preferred embodiment of the present invention, it will be appreciated that numerous changes and modifications are likely to occur to those skilled in the art. It is intended in the appended claims to cover all those changes and modifications which fall within the spirit and scope of the present invention.

What is claimed is:

1. A deep screen reality imaging apparatus, comprising:
a) a projector for providing image-bearing incident light;
b) a translucent rear projection surface for extracting foreground, subject, and background image information;
c) an image panel containing prioritized background information for providing a background image between a second and third plural imaging region;
d) an image panel containing prioritized subject visual information for providing optically neutral void area and subject image between a first and second plural imaging region;
e) an image panel containing prioritized foreground visual information for providing optically neutral void area and foreground image before a first plural image region;
f) semi reflective transmission panels within a darkened optical manifold, a first panel for categorizing extraction and displacement mapping, a second panel for categorizing interpolation and texture mapping, and a third panel for converging multiple layers of visual information; and
g) a primary light trap for displaying a plural 4-dimensional composite image containing interpolated qualities from visual information striking said semi reflective transmissions panels.

2. The deep screen reality imaging apparatus as claimed in claim 1, wherein said rear projection surface is selected from the group consisting of a flexible membrane material and glass.

3. The deep screen reality imaging apparatus as claimed in claim 1, wherein said semi reflective transmissions panels are an aluminized first surface adhered to a flat, rigid, and optically neutral substrate superiorly located to a secondary light-trap.

4. The deep screen reality imaging apparatus as claimed in claim 1, wherein said semi reflective transmission panels are arrayed at 45-degrees parallel to a corresponding independent image extraction region, and prioritized from top to bottom in association with assigned visual information layers.

5. The deep screen reality imaging apparatus as claimed in claim 1, wherein a converged optically plural image is presented using a special heads-up display resulting in a composite synthetic hologram.

6. The deep screen reality imaging apparatus as claimed in claim 1, wherein theater seating, in a darkened auditorium, be situated in a stadium style arrangement with the center seat vertically and horizontally in-line with the primary light trap.

7. The deep screen reality imaging apparatus as claimed in claim 1, wherein the reflectance-transmittance properties of said first plural imaging region is with the reflectance-transmittance properties of said second plural imaging region and further combined with the reflectance-transmittance properties of said third plural imaging region and projected upon a predetermined portion of the primary light trap.

8. The deep screen reality imaging apparatus as claimed in claim 1, wherein said background, said foreground and said subject image panels may be manipulated for providing desired visual affects.

9. The deep screen reality imaging apparatus as claimed in claim 1, wherein editing software is selected from the group consisting of non-linear editing and image extraction.

10. The deep screen reality imaging apparatus as claimed in claim 1, wherein said image conversion is selected from the group consisting of shot in DSR-4 format, and converted to DSR-4 format from existing 2-dementional material.

11. A deep screen reality imaging apparatus, comprising:
a) a video display for providing image-bearing incident light;
b) a translucent rear projection surface for extracting foreground, subject, and background image information;
c) an image panel containing prioritized background-subject information for providing a second plural imaging region;
d) an image panel containing prioritized foreground-subject visual information for providing a first plural imaging region;
e) an image panel containing prioritized foreground visual information for providing optically neutral void area and foreground image before a first plural image region;
f) semi reflective transmission panels within a darkened optical manifold, a first panel for categorizing extraction and displacement mapping, a second panel for categorizing interpolation and texture mapping, and a third panel for converging multiple layers of visual information; and
g) a primary light trap for displaying a plural 4-dimensional composite image containing interpolated qualities from visual information striking said semi reflective transmissions panels.

12. The deep screen reality imaging apparatus as claimed in claim 11, wherein said rear projection surface is selected from the group consisting of a flexible membrane material and glass.

13. The deep screen reality imaging apparatus as claimed in claim 11, wherein said semi reflective transmissions panels are an aluminized first surface adhered to a flat, rigid, and optically neutral substrate superiorly located to a secondary light-trap.

14. The deep screen reality imaging apparatus as claimed in claim 11, wherein said semi reflective transmission panels are arrayed at 45-degrees parallel to a corresponding independent image extraction region, and prioritized from top to bottom in association with assigned visual information layers.

15. The deep screen reality imaging apparatus as claimed in claim 11, wherein a converged optically plural image is presented using a special heads-up display resulting in a composite synthetic hologram.

16. The deep screen reality imaging apparatus as claimed in claim 11, wherein said video display is selected from a group consisting of a CRT, a VDT, a LCD, a HDTV, and a large screen TV.

17. The deep screen reality imaging apparatus as claimed in claim 11, wherein the reflectance-transmittance properties of said first plural imaging region is with the reflectance-transmittance properties of said second plural imaging region and further combined with the reflectance-transmittance properties of said third plural imaging region and projected upon a predetermined portion of the primary light trap.

18. The deep screen reality imaging apparatus as claimed in claim 11, wherein said background, said foreground and said subject image panels may be manipulated for providing desired visual affects.

19. The deep screen reality imaging apparatus as claimed in claim 11, wherein editing software is selected from the group consisting of non-linear editing and image extraction.

20. The deep screen reality imaging apparatus as claimed in claim 11, wherein said image conversion is selected from the group consisting of shot in DSR-4 format, and converted to DSR-4 format from existing 2-dementional material

21. A method of displaying a deep screen reality imaging apparatus in cinema, comprising:
a) using a digital projection in a video projection system;
b) using traditional film projection;
c) using said digital projection and said traditional film projection through an analog to digital format allowing interpolation, extraction and convergence of visual images; and
d) manipulating said visual images through a prioritization mechanism from a software database containing spectral images of 2-demensional visual images and introduction of invariant image extraction and convergence.

22. The method of displaying a deep screen reality imaging apparatus in cinema as claimed in claim 21, including a step of using a LCD in said video system.

23. The method of displaying a deep screen reality imaging apparatus in cinema as claimed in claim 21, including a step of using a DLP in said video system.

24. The method of displaying a deep screen reality imaging apparatus in cinema as claimed in claim 21, including a step of using a 8 mm through 70 mm film in said traditional film projection.

25. A method of displaying a deep screen reality imaging apparatus in video, comprising:
a) using an after-market attachment affixed to a viewing device;
b) using a stand alone self contained component attached during assembly of an electronic display device; and
c) using visual information stored on analog or digital video media allowing interpolation, extraction and convergence of said information; and
d) manipulating said visual information through a prioritization mechanism in said apparatus of 2-demensional visual images and introduction of invariant image extraction and convergence.

26. The method of displaying a deep screen reality imaging apparatus in video as claimed in claim 25, including a step of using a LCD in said video system.

27. The method of displaying a deep screen reality imaging apparatus in video as claimed in claim 25, including a step of using a DLP in said video system.

28. The method of displaying a deep screen reality imaging apparatus in video as claimed in claim 25, including a step of using content selected from a group consisting of a CRT, a VDT, LCD, a HDTV and large screen TV.

29. A method as described in claim 21 including the step of using blue-screen and green-screen electronic matte processes for creation and preparation of content in deep screen reality imaging.

30. A method as described in claim 25 including the step of using blue-screen and green-screen electronic matte processes for creation and preparation of content in deep screen reality imaging.

31. A method as described in claim 21 further including the step of using dark screen limbo technology for creation and preparation of content in deep screen reality imaging.

32. A method as described in claim 25 further including the step of using dark screen limbo technology for creation and preparation of content in deep screen reality imaging.

33. A method as described in claim 21 further including the step of transferring video, film and computer game material with image isolation software for creation and preparation of content in deep screen reality imaging.

34. A method as described in claim 25 further including the step of transferring video, film and computer game material with image isolation software for creation and preparation of content in deep screen reality imaging.

35. The method as described in claim 29 further including the step of interpretation of the relative illumination qualities from the foreground, subject, and background images for creation and preparation of content in deep screen reality imaging.

36. The method as described in claim 30 further including the step of interpretation of the relative illumination qualities from the foreground, subject, and background images for creation and preparation of content in deep screen reality imaging.

37. The method as described in claim 31 further including the step of interpretation of the relative illumination qualities from the foreground, subject, and background images for creation and preparation of content in deep screen reality imaging.

38. The method as described in claim 32 further including the step of interpretation of the relative illumination qualities from the foreground, subject, and background images for creation and preparation of content in deep screen reality imaging.

39. The method as described in claim 33 further including the step of interpretation of the relative illumination qualities from the foreground, subject, and background images for creation and preparation of content in deep screen reality imaging.

40. The method as described in claim 34 further including the step of interpretation of the relative illumination qualities from the foreground, subject, and background images for creation and preparation of content in deep screen reality imaging.

41. The method as described in claim 35 further including the step of computing a relative observation point in a picture plane, said computing having a linear central vanishing point invariance, comprising:
a) an observer primary light trap image display convergence plane;
b) an observer foreground visual image plane;
c) an observer subject image plane; and
d) an observer background image plane.

42. The method as described in claim 36 further including the step of computing a relative observation point in a picture plane, said computing having a linear central vanishing point invariance, comprising:
a) an observer primary light trap image display convergence plane;
b) an observer foreground visual image plane;
c) an observer subject image plane; and
d) an observer background image plane.

43. The method as described in claim 37 further including the step of computing a relative observation point in a picture plane, said computing having a linear central vanishing point invariance, comprising:
a) an observer primary light trap image display convergence plane;
b) an observer foreground visual image plane;
c) an observer subject image plane; and
d) an observer background image plane.

44. The method as described in claim 38 further including the step of computing a relative observation point in a picture plane, said computing having a linear central vanishing point invariance, comprising:
a) an observer primary light trap image display convergence plane;
b) an observer foreground visual image plane;
c) an observer subject image plane; and
d) an observer background image plane.

45. The method as described in claim 39 further including the step of computing a relative observation point in a picture plane, said computing having a linear central vanishing point invariance, comprising:
a) an observer primary light trap image display convergence plane;
b) an observer foreground visual image plane;
c) an observer subject image plane; and
d) an observer background image plane.

46. The method as described in claim 40 further including the step of computing a relative observation point in a picture plane, said computing having a linear central vanishing point invariance, comprising:
a) an observer primary light trap image display convergence plane;
b) an observer foreground visual image plane;
c) an observer subject image plane; and
d) an observer background image plane.

47. A deep screen reality imaging apparatus as claimed in claim 1, wherein near plane observation points are used to view the layered image planes that converge within the darkened optical manifold of said semi reflective-transmission panels, in a deep screen reality image, without the need for special glasses or viewing goggles.

48. A deep screen reality imaging apparatus as claimed in claim 11, wherein near plane observation points are used to view the layered image planes that converge within the darkened optical manifold of said semi reflective-transmission panels, in a deep screen reality image, without the need for special glasses or viewing goggles.

49. The method of displaying a deep screen reality imaging apparatus in cinema as claimed in claim 21, including a step of generating a pre-mastered DSR 4-dimensional polynomial illuminati format footage for DSR 4-dimensional synthetic hologram presentation.

50. The method of displaying a deep screen reality imaging apparatus in cinema as claimed in claim 25, including a step of generating a pre-mastered DSR 4-dimensional binomial illuminati format footage for DSR 4-dimensional synthetic hologram presentation.
